(19) United States
(12) Patent Application Publication
(10) Pub. No.: US 2026/0290948 A1
(43) Pub. Date: Sep. 24, 2026

(54) SECONDARY BATTERY

(71) Applicant: SAMSUNG SDI CO., LTD., Yongin-si (KR)

(72) Inventors: Jeawoan LEE, Yongin-si (KR); Won-Seok KIM, Yongin-si (KR); Hyojin LIM, Yongin-si (KR); Hyunjin HWANG, Yongin-si (KR); Jeonghee PARK, Yongin-si (KR); Soo-Mi EO, Yongin-si (KR)

(21) Appl. No.: 19/308,480

(22) Filed: Aug. 25, 2025

(30) Foreign Application Priority Data
Mar. 18, 2025 (KR) 10-2025-0034395

(51) Int. Cl. H01M 50/103; H01M 50/119; H01M 50/121; H01M 50/124; H01M 50/15; H01M 50/159; H01M 50/16; H01M 50/164; H01M 50/176; H01M 50/186

(52) U.S. Cl. CPC H01M 50/103; H01M 50/119; H01M 50/121; H01M 50/124; H01M 50/15; H01M 50/159; H01M 50/16; H01M 50/164; H01M 50/176; H01M 50/186

(57) ABSTRACT

A secondary battery includes an electrode assembly having a first electrode, a second electrode, and a separator disposed between the first electrode and the second electrode. A body of the secondary battery includes a receiving portion in which the electrode assembly is received and a flange portion on an outer side. A cover is disposed on the body to seal the receiving portion. A bent portion is formed at which the body and the cover are integrally connected and bent. An electrode terminal is disposed on a side surface of the body that comprises the bent portion. The body and the cover each includes a metal layer, a polymer layer, and an adhesive layer interposed between the metal layer and the polymer layer.

### CROSS-REFERENCE TO RELATED APPLICATION

This application claims priority under 35 U.S.C. § 119 to Korean Patent Application No. 10-2025-0034395, filed in the Korean Intellectual Property Office on Mar. 18, 2025, the entire contents of which are hereby incorporated by reference.

### BACKGROUND

### Field

The present disclosure relates to a secondary battery.

### DESCRIPTION OF THE RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Because the layout parts changes when a new model of a small electronic device (such as a smart phone) is released and because there is a constant demand for weight reduction, pouch-type batteries having excellent flexibility and a comparatively light weight are widely used in such small electronic devices. However, wrinkles or deformation may occur in the exterior of a pouch-type battery formed with a flexible composite material when the battery is replaced after being mounted in a battery installation space. To prevent this, a battery with a metal case has been proposed, but such a battery has a drawback in that the weight of the battery increases because the metal case must have a certain thickness.

The above information disclosed in this Background section is for enhancement of understanding of the background of the present disclosure, and therefore, it may contain information that does not constitute related (or prior) art.

### SUMMARY

An object of the present disclosure is to provide a secondary battery that overcomes the above-described problems.

These and other aspects and features of the present disclosure will be described in or will be apparent from the following description of embodiments of the present disclosure.

According to an embodiment of the present disclosure, a secondary battery may include an electrode assembly comprising a first electrode, a second electrode, and a separator disposed between the first electrode and the second electrode, a body that includes a receiving portion in which the electrode assembly is accommodated and a flange portion on an outer side of the body, a cover disposed on the body so as to seal the receiving portion, a bent portion at which the body and the cover are integrally connected and bent, and an electrode terminal disposed on a side surface of the body that includes the bending portion. The body and the cover may each include a metal layer, a polymer layer, and an adhesive layer interposed between the metal layer and the polymer layer.

According to an embodiment of the present disclosure, a case of the secondary battery that includes the body and the cover may have a rectangular parallelepiped shape, the flange portion may be formed on three side surfaces of the body, and the flange portion may be absent from the side surface of the body on which the electrode terminal is disposed.

According to an embodiment of the present disclosure, the flange portion may include a first flange portion extending outward from an upper end of the side surface of the body that faces the side surface on which the electrode terminal is disposed, and second and third flange portions each including an extension portion extending outward from upper ends of side surfaces of the body adjacent to the side surface on which the electrode terminal is disposed.

According to an embodiment of the present disclosure, a width of the first flange portion in a first direction may be greater than widths of the second flange portion and the third flange portion in a second direction that is perpendicular to the first direction.

According to an embodiment of the present disclosure, the second flange portion and the third flange portion may each further include a second extension portion that is bent and extends from the first extension portion.

According to an embodiment of the present disclosure, the polymer layer of the body and the polymer layer of the cover may be bonded to each other.

According to an embodiment of the present disclosure, the metal layer may include stainless steel.

According to an embodiment of the present disclosure, the metal layer may include aluminum.

According to an embodiment of the present disclosure, a thickness of the metal layer may be 20 μm to 80 μm.

According to an embodiment of the present disclosure, the polymer layer may include cast polypropylene (CPP).

According to an embodiment of the present disclosure, the electrode terminal may have a rivet shape and may couple with the body by extending through at least one side surface of the body.

According to an embodiment of the present disclosure, the secondary battery may further include a side plate electrically connected to the electrode terminal, an insulating member interposed between the side plate and the body, and a gasket interposed between the electrode terminal and the body.

According to an embodiment of the present disclosure, the electrode terminal protrudes from the side surface of the body.

According to another embodiment of the present disclosure, a secondary battery may include an electrode assembly having a first electrode, a second electrode, and a separator disposed between the first electrode and the second electrode, a body that includes a receiving portion in which the electrode assembly is accommodated and a flange portion formed along an outer circumference of the body, a cover disposed on the body so as to seal the receiving portion, and an electrode terminal disposed on a side surface of the body. The body and the cover may each include a metal layer, a polymer layer, and an adhesive layer interposed between the metal layer and the polymer layer.

According to an embodiment of the present disclosure, a case of the secondary battery that includes the body and the cover may have a rectangular parallelepiped shape, and the flange portion may be formed on four side surfaces of the body.

According to an embodiment of the present disclosure, the flange portion may include first and second flange portions respectively extending outward an upper end of the surface of the body on which the electrode terminal is disposed and a side surface of the body that is opposite to the side surface of the body on which the electrode terminal is disposed, and third and fourth flange portions each including a first extension portion extending outward from an upper end of a side surface of the body that is adjacent to the side surface of the body on which the electrode terminal is disposed.

According to an embodiment of the present disclosure, the third flange portion and the fourth flange portion may each further include a second extension portion that is bent and extends from the first extension portion.

According to an embodiment of the present disclosure, the polymer layer of the body and the polymer layer of the cover may be bonded to each other.

According to an embodiment of the present disclosure, the metal layer may include stainless steel.

According to an embodiment of the present disclosure, a thickness of the metal layer may be 20 μm to 80 μm.

According to embodiments of the present disclosure, because the electrode terminal is formed in the bent portion of the secondary battery case, an area of the case that would otherwise be removed during the manufacturing process of the secondary battery can be minimized. Accordingly, a larger space for accommodating the electrode assembly can be secured, and ultimately, a secondary battery having a high energy density can be provided.

According to embodiments of the present disclosure, the secondary battery can be light-weight by forming the case using a material including the metal layer and the polymer layer.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of a secondary battery according to an embodiment of the present disclosure.

FIG. 2 is a perspective view of a secondary battery according to an embodiment of the present disclosure.

FIG. 3 illustrates an electrode terminal of a secondary battery according to an embodiment of the present disclosure is coupled to a case.

FIG. 4 is a plan view of a secondary battery according to an embodiment of the present disclosure before a body and a cover are folded along a bending portion.

FIG. 5 is a plan view of a secondary battery according to an embodiment of the present disclosure in which the body and the cover are folded along the bending portion.

FIG. 6 is a plan view where the body and the cover are sealed during a manufacturing process of a secondary battery according to an embodiment of the present disclosure.

FIG. 7 is a plan view of a secondary battery obtained through the manufacturing process according to an embodiment of the present disclosure.

FIG. 8 is a front view of a secondary battery obtained through the manufacturing process according to an embodiment of the present disclosure.

FIG. 9 illustrates a laminated structure included in the body of a secondary battery according to an embodiment of the present disclosure.

FIG. 10 illustrates a laminated structure included in the cover of a secondary battery according to an embodiment of the present disclosure.

FIG. 11 is a front view of a secondary battery in which the body and the cover are folded along the bending portion and sealed.

FIG. 12 is an exploded perspective view of a secondary battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

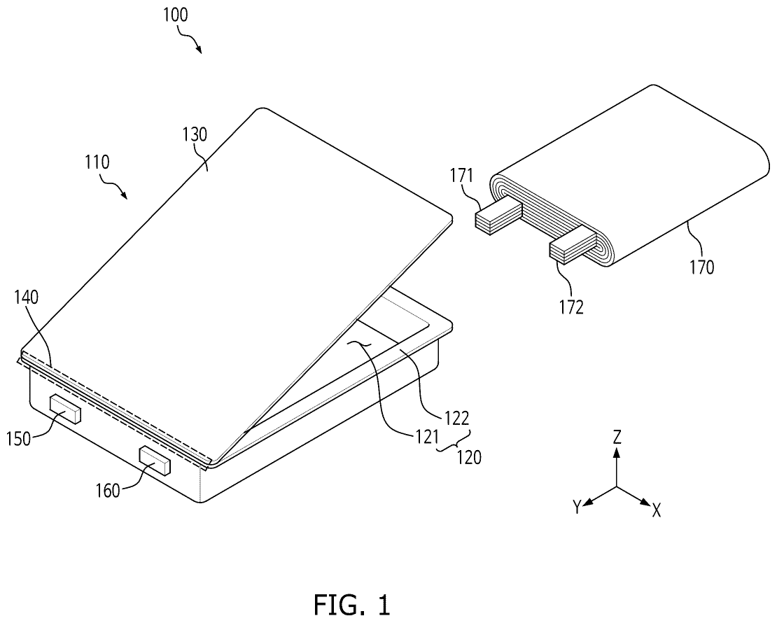

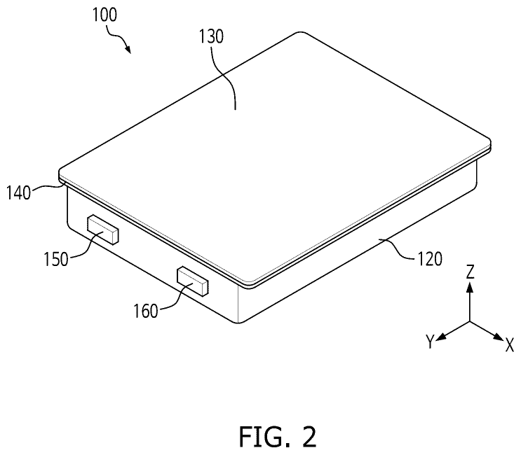

FIGS. 1 and 2 illustrate a secondary battery 100 according to an embodiment of the present disclosure.

Referring to FIG. 1, the secondary battery 100 according to an embodiment of the present disclosure may include an electrode assembly 170 that includes a first electrode, a second electrode, and a separator disposed between the first electrode and the second electrode, a body 120 that includes a receiving portion 121 for accommodating the electrode assembly 170 and a flange portion 122 on an outer side, a cover 130 disposed on the body 120 to seal the receiving portion 121, a bending portion 140 at which the body 120 and the cover 130 are integrally connected and bent, and electrode terminals 150 and 160 disposed at one side surface of the body 120 that includes the bending portion 140. Each of the body 120 and the cover 130 may include a metal layer, a polymer layer, and an adhesive layer interposed between the metal layer and the polymer layer.

An electrode assembly 170 may be formed by winding or stacking a stack of a first electrode plate, a separator, and a second electrode plate, which are formed as thin plates or films. When the electrode assembly 170 is a wound stack, a winding axis may be parallel to the longitudinal direction (e.g., the y direction) of the case 110. In other embodiments, the electrode assembly 170 may be a stack type rather than a winding type, and the shape of the electrode assembly 170 is not limited in the present disclosure. In addition, the electrode assembly 170 may be a Z-stack electrode assembly in which a positive electrode plate and a negative electrode plate are inserted into both sides of a separator, which is then bent into a Z-stack. In addition, one or more electrode assemblies 170 may be stacked such that long sides of the electrode assemblies 170 are adjacent to each other and accommodated in the case 110, and the number of electrode assemblies 170 in the case 110 is not limited in the present disclosure. The first electrode plate of the electrode assembly 170 may act as a negative electrode, and the second electrode plate may act as a positive electrode. Of course, the reverse is also possible. Therefore, the first electrode plate of the electrode assembly may act as a positive electrode, and the second electrode plate may act as a negative electrode.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab 171 (e.g., a first uncoated portion) that is a region to which the first electrode active material is not applied. The first electrode tab 171 may act as a current flow path between the first electrode plate and the first current collector. In some embodiments, when the first electrode plate is manufactured, the first electrode tab 171 may be formed by being cut in advance to protrude to one side of the electrode assembly, or the first electrode tab 171 may protrude to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 172 (e.g., a second uncoated portion) that is a region to which the second electrode active material is not applied. The second electrode tab 172 may act as a current flow path between the second electrode plate and the second current collector. In some embodiments, the second electrode tab 172 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTio3, Mg(OH)2, boehmite, and a combination thereof, but is not limited thereto.

The organic material and the inorganic material may be mixed in one coating layer, or a coating layer including an organic material and a coating layer including an inorganic material may be stacked.

The case 110 of the secondary battery 100 may include the body 120 and the cover 130. A bent portion 140 may be formed at a region where at least one edge of the body 120 and at least one edge of the cover 130 meet each other, so that the body 120 and the cover 130 are integrally connected and can be bent about the bent portion 140.

The body 120 may include the receiving portion 121 having an opening at one end for accommodating the electrode assembly 170. The body 120 may be constituted by a bottom and four sidewalls that extend perpendicularly from the bottom, thereby defining the receiving portion 121 of the body 120. For example, the sidewalls may comprise two long sides facing each other and two short sides facing each other, and the body 120 may be provided in the form of a box having an opening at one end. The electrode assembly 170 may be disposed so as to be supported by the bottom of the case and surrounded by the four sidewalls inside the body 120.

The body 120 may further include the flange portion 122 that extends in a horizontal direction from an upper end of the body 120 so as to surround the receiving portion 121. However, the flange portion 122 may not be formed on the one side surface of the body 120 that includes the bending portion 140. For example, when the electrode terminals 150 and 160 are disposed on the side surface of the body 120 that includes the bending portion 140, the flange portion 122 may be formed on three side surfaces of the body 120 but not the side surface on which the electrode terminals 150 and 160 are disposed.

The cover 130 may be plate-shaped and may be formed of the same material as the body 120.

The secondary battery 100 may include the electrode terminals 150 and 160 disposed at the one side surface of the body 120 that includes the bent portion 140. Because the electrode terminals 150 and 160 are disposed on the side surface of the body 120 that includes the bent portion 140, the flange portion does not need to be formed on that side surface. Accordingly, the accommodation space for the electrode assembly 170 can be expanded, thereby improving the energy density of the secondary battery 100.

According to an embodiment of the present disclosure, the electrode terminals 150 and 160 may protrude from the side surface of the body 120. That is, the electrode terminals 150 and 160 may be disposed to protrude outward from the side surface of the body 120 that includes the bent portion 140. The electrode terminals may include a first electrode terminal 150 and a second electrode terminal 160. The first electrode terminal 150 and the second electrode terminal 160 may each be disposed by being welded to the body 120. The first electrode terminal 150 and the second electrode terminal 160 be electrically connected to the first electrode tab 171 and the second electrode tab 172 of the electrode assembly 170, respectively, to connect the electrode assembly 170 to an external power source or load.

Referring to FIG. 2, in a state in which the case 110 of the secondary battery 100 is open—that is, before the body 120 and the cover 130 come into contact with each other as in FIG. 1—the electrode assembly 170 is accommodated in the body 120. The cover 130 is then bent about the bent portion 140 until the cover 130 comes into contact with the body 120. Thus, the secondary battery 100 in which the electrode assembly 170 is sealed in the case 110 may be manufactured.

The secondary battery 100 may include a lithium battery cell, a sodium battery cell, or the like. However, the scope of the present disclosure is not limited thereto, and the present disclosure includes various other types of batteries they can repeatedly supply electricity through charge and discharge. When the secondary battery 100 is a lithium battery cell, it may excellent cycle characteristics and high-rate characteristics such that it can be used, for example, in an electric vehicle (EV) or in a hybrid vehicle such as a plug-in hybrid electric vehicle (PHEV). In addition, the lithium battery cell can be used in fields requiring storage of power, such as smart phones, tablet PCs, electric bicycles, and power tools. But the present disclosure is not limited to these examples.

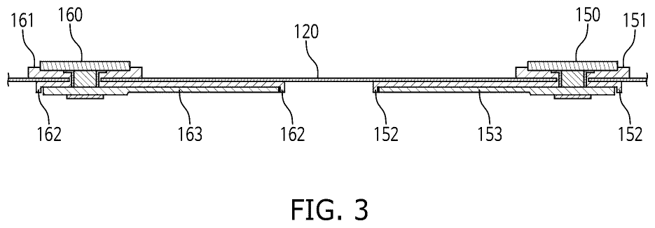

FIG. 3 illustrates a structure in which an electrode terminal of a secondary battery according to an embodiment of the present disclosure is coupled to a case.

Referring to FIG. 3, the electrode terminals 150 and 160 included in the secondary battery 100 may have a rivet shape and be coupled to the body 120 by extending through at least one side surface of the body 120. The side surface of the body 120 through which the electrode terminals 150 and 160 extend may be, for example, the side surface of the body 120 that includes the bent portion 140.

An upper portion of the first electrode terminal 150 may include a head having a diameter greater than a horizontal length of a through-hole of the body 120 through which the first electrode terminal 150 extends. A body part of the first electrode terminal 150 may be connected to the head of the first electrode terminal 150 and may extend through the through-hole of the body 120 to a lower surface of a first side plate 153.

An upper portion of the second electrode terminal 160 may include a head having a diameter greater than a horizontal length of a through-hole of the body 120 through which the second electrode terminal 160 extends. A body part of the second electrode terminal 160 may be connected to the head of the second electrode terminal 160 and may extend through the through-hole of the body 120 to a lower surface of a second side plate 163.

A first gasket 151 may be interposed between the body 120 and the first electrode terminal 150. The first gasket 151 may electrically insulate the body 120 from the first electrode terminal 150. The first gasket 151 may be in contact with the body 120 and the head and the body part of the first electrode terminal 150. More specifically, the first gasket 151 may be in contact with the body 120, the first electrode terminal 150, and a first insulating member 152, whereby the first electrode terminal 150 can be stably coupled to the body 120 and can serve to alleviate impacts applied to the secondary battery 100.

A first insulating member 152 may be disposed on a lower side of the body 120 where the first gasket 151 is disposed, and the first insulating member 152 may be in contact with the body 120 and the body part of the first electrode terminal 150. The first insulating member 152 may function to electrically insulate the body 120 from the first side plate 153, as will be described below.

A first side plate 153 may be disposed on a side of the first electrode terminal 150 and a lower side of the first insulating member 152 and be in contact with the body part of the first electrode terminal 150 and the first insulating member 152. The first side plate 153 may be welded to and electrically connected to the first electrode terminal 150.

A second gasket 161 may be interposed between the body 120 and the second electrode terminal 160. The second gasket 161 may be in contact with the body 120 and the head and the body part of the second electrode terminal 160. A second insulating member 162 may be disposed on a lower side of the body 120 where the second gasket 161 is disposed and be in contact with the body 120 and the body part of the second electrode terminal 160. A second side plate 163 may be disposed on a side of the second electrode terminal 160 and a lower side of the second insulating member 162, and the second side plate may be in contact with the body part of the second electrode terminal 160 and the second insulating member 162. The functions of the second gasket 161, the second insulating member 162, and the second side plate 163 may be the same as the functions of the first gasket 151, the first insulating member 152, and the first side plate 153, respectively.

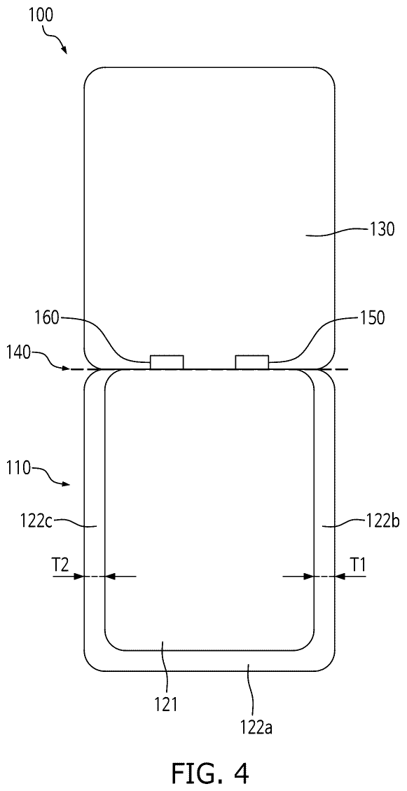

Hereinafter, with reference to FIGS. 4 to 7, a specific structure and shape of the secondary battery 100 according to a manufacturing process of the secondary battery 100 will be described in detail.

FIG. 4 is a plan view showing the secondary battery 100 before the body 120 and the cover 130 are folded along the bent portion 140 during a manufacturing process.

Referring to FIG. 4, the secondary battery 100 according to an embodiment of the present disclosure can be manufactured by forming the case 110 that includes the bent portion 140 where the body 120 and the cover 130 are integrally connected and bent.

The flange portion 122 may include a first flange portion 122a extending outward from an upper end of a side surface of the body 120 that faces the side surface on which the electrode terminals 150 and 160 are disposed. Second and third flange portions 122b and 122c may extend outward from upper ends of both side surfaces of the body 120 adjacent to the side surface on which the electrode terminals 150 and 160 are disposed. In a pre-molding state for manufacturing the secondary battery 100, a width of the first flange portion 122a in a first direction—that is, a direction in which the first flange portion 122a extends outward from the receiving portion 121—may be the same as widths T1 and T2 of the second flange portion 122b and the third flange portion 122c in a second direction that is perpendicular to the first direction. However, the widths of the first flange portion 122a, the second flange portion 122b, and the third flange portion 122c are not limited to such a configuration and may vary depending on a shape of the receiving portion 121 of the body 120.

Other features of the case 110 may be the same as those described with reference to FIG. 1.

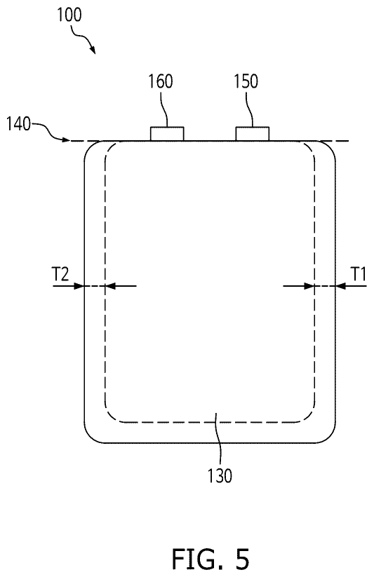

FIG. 5 is a plan view illustrating a state of the secondary battery 100 according to an embodiment of the present disclosure, in which the body 120 and the cover 130 are folded along the bent portion 140 during a manufacturing process of the secondary battery 100.

Referring to FIG. 5, after the electrode assembly is positioned in the receiving portion, the cover 130 can be folded along the bent portion 140 so as to come into surface contact with the body 120 and thereby seal the electrode assembly. Portions of the cover 130 may contact the first flange portion 122a, the second flange portion 122b, and the third flange portion 122c of the body 120. The cover 130 may be configured as a flat plate disposed on the body 120 so as to seal the receiving portion 121.

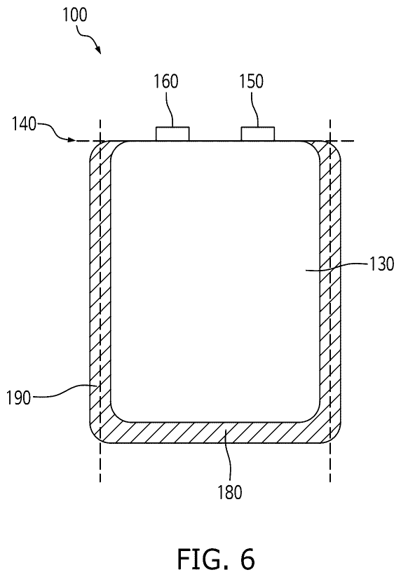

FIG. 6 is a plan view illustrating regions where the body 120 and the cover 130 are sealed during a manufacturing process of the secondary battery 100 according to an embodiment of the present disclosure.

Referring to FIG. 6, after the cover 130 contacts the first flange portion 122a, the second flange portion 122b, and the third flange portion 122c, the cover 130 and the flange portions may be bonded together along the flange portions to form a sealing portion 180. The cover 130 may be bonded by heat fusion along the sealing portion 180, whereby the receiving portion 121 can be sealed. The heat fusion can be, for example, bonding of polymer layers of laminated structures of the body 120 and the cover 130. However, the present disclosure is not limited in this regard, and various other methods can be used to bond and seal the body 120 and the cover 130, such as laser welding, may be used.

After the case of the secondary battery is bonded by heat fusion, the second flange portion 122b and the third flange portion 122c can be folded along a fold line 190. The folding can be in a direction perpendicular to a bottom surface, that is, from the body 120 toward the cover 130.

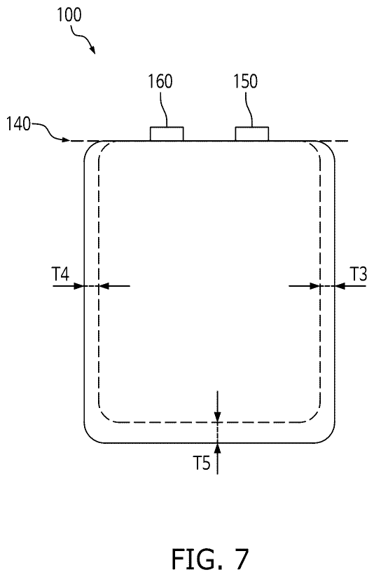

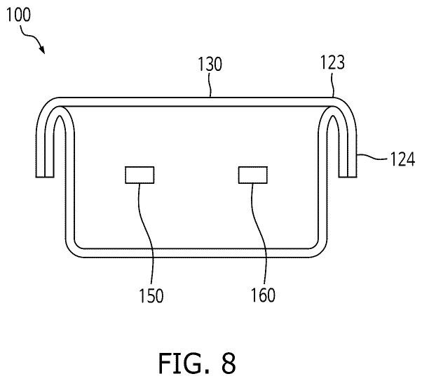

FIGS. 7 and 8 are a plan view and a front view, respectively, illustrating a secondary battery obtained through the manufacturing process according to an embodiment of the present disclosure.

Referring to FIG. 7, the flange portion may include a first flange portion extending outward from an upper end of a side surface of the body on which the electrode terminals 150 and 160 are disposed. The flange portion also includes a second and a third flange portion each including a first extension portion extending outward from upper ends of both side surfaces of the body adjacent to the side surface on which the electrode terminals 150 and 160 are disposed. Each of the second and the third flange portions may further include a second extension portion that is bent and extends from the first extension portion. The second extension portions can be formed by the folding process described above with reference to FIG. 6.

In the manufactured secondary battery 100, the width T5 of the first flange portion in the first direction may be greater than the widths T3, T4 of the second flange portion and the third flange portion in the second direction, with the first and second directions being perpendicular to each other. This is because the second flange portion and the third flange portion include the first extension portion and the second extension portion that are bent and extend from the first extension portion formed through a folding process, which results in a difference from the widths in the second direction of the second flange portion and the third flange portion that are formed on the body before the manufacture of the rest of secondary battery 100.

Referring to FIG. 8, each second extension portion 124 included in the second flange portion 122b and the third flange portion 122c may have a shape that is bent and extended from the first extension portion 123. As illustrated in FIG. 8, a direction that the second extension portion 124 is bent from the first extension portion 123 may be a direction from the cover 130 toward the body. However, the direction that the second extension portion 124 is bent may also be a direction substantially perpendicular to the first extension portion 123, and the present disclosure is not limited in this regard.

After the cover 130 is sealed to the second flange portion 122b and the third flange portion 122c by heat fusion, during the process of folding the second flange portion 122b and the third flange portion 122c portions of the cover 130 that are heat-fused to the first extension portions 123 and the second extension portions 124 of the second flange portion 122b and the third flange portion 122c may also be bent in the same direction as the second extension portions 124.

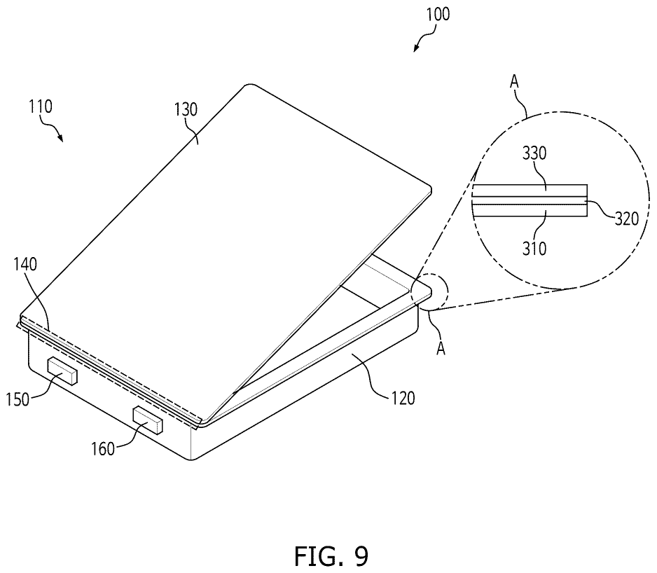

Hereinafter, with reference to FIGS. 9 to 11, a laminated structure included in the body and the cover will be described in detail.

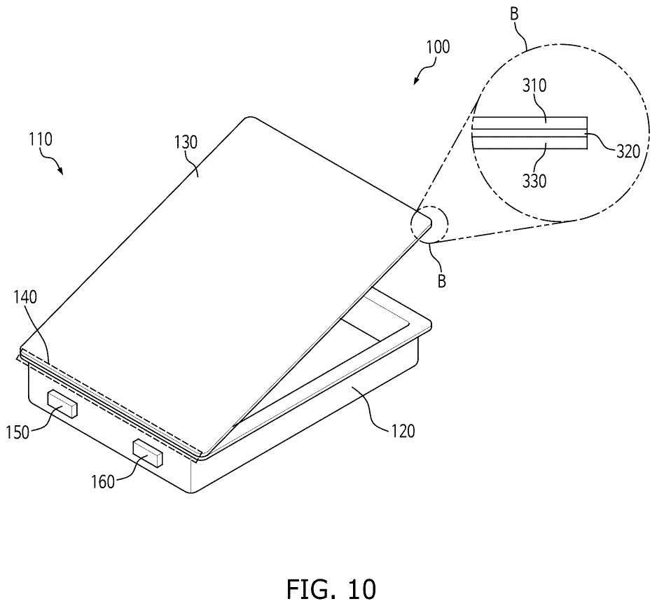

FIG. 9 illustrates a laminated structure A included in the body 120 of the secondary battery 100 according to an embodiment of the present disclosure, and FIG. 10 illustrates a laminated structure B included in the cover 130 of the secondary battery 100 according to an embodiment of the present disclosure.

Referring to FIG. 9, the body 120 may include the laminated structure A that includes a metal layer 310, a polymer layer 330, and an adhesive layer 320 interposed between the metal layer 310 and the polymer layer 330. The laminated structure A may be formed by sequentially laminating the metal layer 310 that is exposed to outside of the secondary battery, the adhesive layer 320 disposed on the metal layer 310, and the polymer layer 330 disposed on the adhesive layer 320. In a specific example, the laminated structure A may be formed by laminating the polymer layer 330 on the adhesive layer 320 that is coated on one surface of the metal layer 310 by a lamination process.

The metal layer 310 may include stainless steel or aluminum. A thickness of the metal layer 310 may be 20 μm to 80 μm, or 20 μm to 40 μm. When the thickness of the metal layer 310 is less than 20 μm, the case 110 may be structurally too weak, making it difficult to form the electrode terminals 150 and 160 in a rivet shape. When the thickness of the metal layer 310 exceeds 80 μm, folding the second flange portion and the third flange portion in the second direction after heat fusion may be difficult.

The polymer layer 330 may include cast polypropylene (CPP). A thickness of the polymer layer 330 may be 20 μm to 30 μm.

Referring to FIG. 10, the cover 130 may include the laminated structure B that includes a metal layer 310, a polymer layer 330, and an adhesive layer 320 interposed between the metal layer 310 and the polymer layer 330. The laminated structure B may be formed, for example, by sequentially laminating the polymer layer 330, the adhesive layer 320 disposed on the polymer layer 330, and the metal layer 310 disposed on the adhesive layer 320 and exposed to outside of the secondary battery.

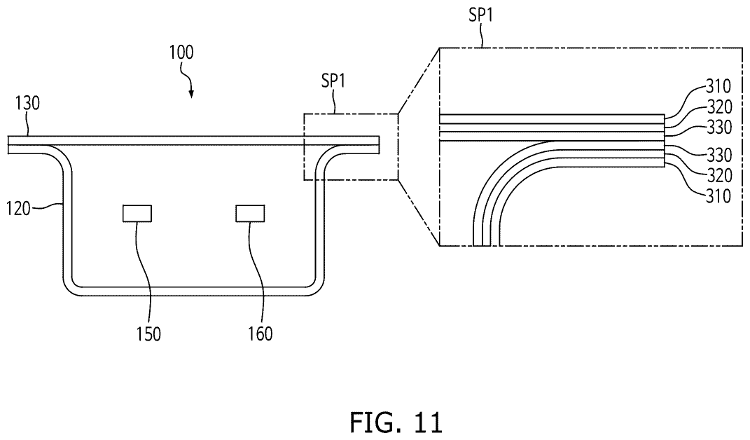

FIG. 11 is a front view illustrating the secondary battery 100 in which the body 120 and the cover 130 are folded along the bending portion and sealed during a manufacturing process of the secondary battery 100.

Referring to FIG. 11, when an electrode assembly (not shown) is accommodated in the body 120, the flange portion of the body 120 may be sealed to a portion of the cover 130. Here, the portion of the cover 130 may correspond to a region facing the flange portion of the body 120.

In a region SP1 where the body 120 and the cover 130 are sealed, the body 120 may have a structure in which the metal layer 310, the adhesive layer 320, and the polymer layer 330 are sequentially laminated, as described above with reference to FIG. 8. The cover 130 may have a structure in which the polymer layer 330, the adhesive layer 320, and the metal layer 310 are sequentially laminated, as described above with reference to FIG. 9. Thus, the polymer layer 330 of the body 120 and the polymer layer 330 of the cover 130 may be bonded to each other by heat fusion. However, the scope of the present disclosure is not limited to such a configuration and manufacturing process.

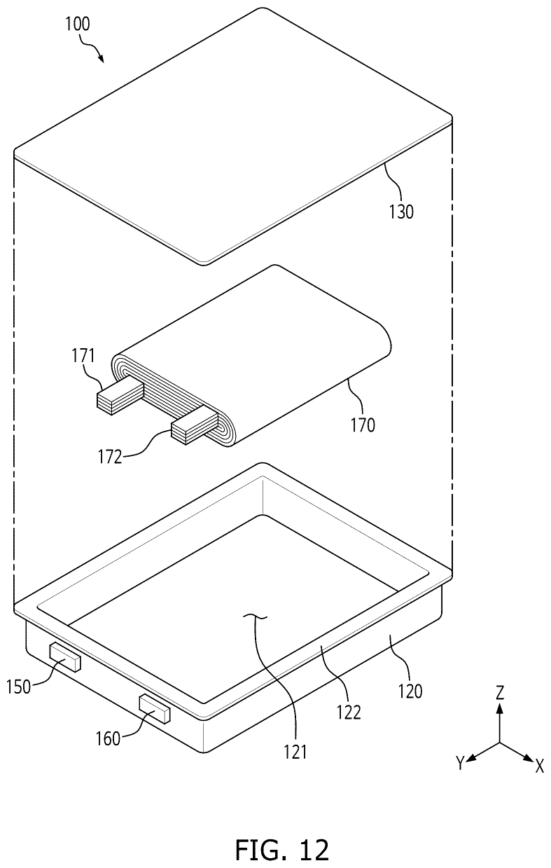

FIG. 12 is an exploded perspective view of a secondary battery 100 according to an embodiment of the present disclosure.

Referring to FIG. 12, the secondary battery 100 may include an electrode assembly 170 comprising a first electrode, a second electrode, and a separator disposed between the first electrode and the second electrode. The secondary battery 100 may also include a body 120 that includes the receiving portion 121 for accommodating the electrode assembly 170 and the flange portion 122 formed along an outer circumference. A cover 130 is disposed on the body 120 to seal the receiving portion 121, and electrode terminals 150 and 160 are disposed on a surface of the body 120. Each of the body 120 and the cover 130 may include a metal layer, a polymer layer, and an adhesive layer interposed between the metal layer and the polymer layer.

The body 120 may have a bottom and four side surfaces that extend perpendicularly from the bottom. The flange portion 122 may be formed on the four side surfaces of the body 120. Specifically, the flange portion 122 may include first and second flange portions extending outward from upper ends of the first side surface of the body 120 on which the electrode terminals 150 and 160 are disposed and a second side surface of the body 120 opposite to the side surface. The flange portion may also include third and fourth flange portions each including a first extension portion extending outward from upper ends of third and fourth side surfaces of the body 120 adjacent to the first side surface. Each of the third flange portion and the fourth flange portion may further include a second extension portion that is bent and extends from the first extension portion. The second extension portion may be formed through the folding process during the manufacturing of the secondary battery 100, and the above descriptions with reference to FIGS. 7 and 8 applies in this regard. However, the first flange portion and the second flange portion may also have a bent shape, and the present disclosure is not limited in this regard.

Except for the flange portion 122 formed on the four side surfaces of the body 120, the remaining configuration of the secondary battery 100 may be the same as described above with reference to FIG. 1-11.

Although the present disclosure has been described above with respect to embodiments thereof, the present disclosure is not limited thereto. Various modifications and variations can be made thereto by those skilled in the art within the spirit of the present disclosure.

### DESCRIPTION OF REFERENCE SYMBOLS

100: secondary battery
110: case
120: body
130: cover
150: first electrode terminal
160: second electrode terminal
170: electrode assembly
171: first electrode tab
172: second electrode tab

What is claimed is:

1. A secondary battery comprising:
an electrode assembly comprising a first electrode, a second electrode, and a separator disposed between the first electrode and the second electrode;
a body comprising a receiving portion in which the electrode assembly is accommodated, with a flange portion being formed on an outer side of the body;
a cover disposed on the body to seal the receiving portion;
a bent portion at which the body and the cover are integrally connected and bent; and
an electrode terminal disposed on a side surface of the body comprising the bent portion,
wherein the body and the cover each comprise a metal layer, a polymer layer, and an adhesive layer interposed between the metal layer and the polymer layer.

2. The secondary battery according to claim 1, wherein the body has a bottom and four side surfaces extending perpendicularly from the bottom,
wherein the flange portion is formed on three side surfaces of the body and is not formed on the side surface of the body on which the electrode terminal is disposed.

3. The secondary battery according to claim 1, wherein the flange portion comprises:
a first flange portion extending outward from an upper end of a side surface of the body facing the side surface on which the electrode terminal is disposed; and
second and third flange portions each comprising an extension portion extending outward from upper ends of side surfaces of the body adjacent to the side surface on which the electrode terminal is disposed.

4. The secondary battery according to claim 3, wherein a width of the first flange portion in a first direction is greater than widths of the second flange portion and the third flange portion in a second direction that is perpendicular to the first direction.

5. The secondary battery according to claim 3, wherein the extension portion is a first extension portion, and
wherein each of the second flange portion and the third flange portion further comprises a second extension portion that is bent and extends from the first extension portion.

6. The secondary battery according to claim 1, wherein the polymer layer of the body and the polymer layer of the cover are bonded to each other.

7. The secondary battery according to claim 1, wherein the metal layer comprises stainless steel.

8. The secondary battery according to claim 1, wherein the metal layer comprises aluminum.

9. The secondary battery according to claim 1, wherein a thickness of the metal layer is 20 μm to 80 μm.

10. The secondary battery according to claim 1, wherein the polymer layer comprises cast polypropylene.

11. The secondary battery according to claim 1, wherein the electrode terminal has a rivet shape and is coupled to the body by extending through at least one side surface of the body.

12. The secondary battery according to claim 11, further comprising:
a side plate electrically connected to the electrode terminal;
an insulating member interposed between the side plate and the body; and
a gasket interposed between the electrode terminal and the body.

13. The secondary battery according to claim 1, wherein the electrode terminal protrudes from the side surface of the body.

14. A secondary battery comprising:
an electrode assembly comprising a first electrode, a second electrode, and a separator disposed between the first electrode and the second electrode;
a body comprising a receiving portion in which the electrode assembly is accommodated, with a flange portion being formed along an outer circumference of the body;
a cover disposed on the body to seal the receiving portion; and
an electrode terminal disposed on a side surface of the body,
wherein the body and the cover each comprise a metal layer, a polymer layer, and an adhesive layer interposed between the metal layer and the polymer layer.

15. The secondary battery according to claim 14, wherein the body has a bottom and four side surfaces extending perpendicularly from the bottom,
wherein the flange portion is formed on the four side surfaces of the body.

16. The secondary battery according to claim 14, wherein the flange portion comprises:
a first flange portion and a second flange portion respectively extending outward from upper ends of side surface of the body on which the electrode terminal is disposed and a side surface of the body that is opposite to the side surface of the body on which the electrode terminal is disposed; and
a third flange portion and a fourth flange portion each of which comprises an extension portion extending outward from an upper end of a side surface of the body that is adjacent to the side surface of the body on which the electrode terminal is disposed.

17. The secondary battery according to claim 16, wherein the extension portion is a first extension portion, and
wherein the third flange portion and the fourth flange portion each comprises a second extension portion that is bent and extends from the first extension portion.

18. The secondary battery according to claim 14, wherein the polymer layer of the body and the polymer layer of the cover are bonded to each other.

19. The secondary battery according to claim 14, wherein the metal layer comprises stainless steel.

20. The secondary battery according to claim 14, wherein a thickness of the metal layer is 20 μm to 80 μm.
